(19) United States
(12) Patent Application Publication
(10) Pub. No.: US 2008/0290801 A1
(43) Pub. Date: Nov. 27, 2008

(54) Metal Halide Lamp, Metal Halide Lamp Lighting Device and Headlight

(76) Inventors: Kozo Uemura, Ehime-ken (JP); Keisuke Nakazato, Ehime-ken (JP); Hiromichi Kawashima, Ehime-ken (JP); Osamu Shirakwa, Ehime-ken (JP); Makoto Deguchi, Ehime-ken (JP); Takayuki Wajata, Ehime-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/631,155

(22) PCT Filed: Jun. 28, 2005
(86) PCT No.: PCT/JP05/11845

§ 371 Date: Dec. 29, 2006

(30) Foreign Application Priority Data
Jun. 30, 2004 (JP) 2004-193066

(51) Int. Cl. H01J 61/30

(52) U.S. Cl. 313/634

(57) ABSTRACT

There are provided a mercury-free metal halide lamp which is improved in light flux rising immediately after starting, more practical and suitable for a headlight, and a metal halide lamp lighting device and a headlight using this. The metal halide lamp according to the present invention comprises: a translucent air-tight container having an inner volume which is not grater than 0.1 cc, including an enclosure portion forming an inner space having a flat surface on a bottom surface, and having a ratio D/L satisfying the following expression: 0.25 ≦ D/L ≦ 0.43 where D is a distance between the bottom surface and a top surface of the inner space at a central portion in a tube-axis direction, and L is a length of the enclosure portion; a pair of electrodes sealed facing each other with an inter-electrode distance which is not greater than 5 mm; and a discharging medium containing a plurality of metal halogen compounds selected from a group of Sc, Na, In, Zn and a rare-earth metal and a rare gas but intrinsically not containing mercury (Hg), wherein a lamp power per unit inner surface area of the air-tight container is not smaller than 60 (W/cm²).

### TECHNICAL FIELD

The present invention relates to a mercury-free metal halide lamp, a metal halide lamp lighting device and a headlight using this.

### BACKGROUND OF THE INVENTION

A so-called mercury-free metal halide lamp (which will be referred to as a “mercury-free lamp” hereinafter for the convenience's sake) in which mercury is not essentially enclosed has been already known (see, e.g., Patent Literature 1). In the mercury-free lamp, generally, metal halogen compounds such as zinc, which have a relatively high steam pressure and hardly emit light in a visible range, are enclosed in place of mercury enclosed as a conventional lamp voltage forming buffer substance.

In particular, the mercury-free lamp has been expected and developed as a headlight metal halide lamp of a car from which use of environment burden materials is to be completely abolished. In case of this metal halide lamp, a light flux which is 80% of a rated light flux must be generated after four seconds from starting based on standards (see Non-Patent Literature 1). However, it is generally difficult for the mercury-free lamp to satisfy the above-described conditions since mercury light emission cannot be obtained and a high stream pressure of mercury cannot be obtained immediately after lighting, whereby vaporization of a metal halogen compound is delayed.

Thus, several proposals have been conventionally provided to meet the above-described conditions. For example, there is a proposal characterized in that an inner volume and a wall thickness of an arc tube and a pressure of an Xe gas are selected to fall within predetermined ranges and a metal halogen compound having a low fusing point is enclosed (see Patent Literature 2). Furthermore, there is another proposal to select an internal diameter of an arc tube, a protruding length of an electrode, a wall thickness, an input power, an Xe enclosing pressure and others are selected to fall within predetermined ranges (see Patent Literature 3). Moreover, there is still another proposal of improving an initial rise of light flux based on a relationship between an internal diameter of an arc tube and a diameter of an arc (see Patent Literature 4).

On the other hand, there is an attempt to change a shape of an inner space of an arc which is a substantially cylindrical shape as a general shape for this type of application to a different shape. For example, Patent Literature 3 discloses several shapes in FIG. 11 thereof, but this reference has a proposal that a lower inner surface (a bottom surface) of an inner space is formed into a flat surface and a ratio of a distance Hd in a direction perpendicular to an axial line 13 running through a space between electrodes and an inter-electrode distance L is selected to fall within a predetermined range. Moreover, there is also an attempt to flatten a lower outer surface in addition to forming a lower inner surface (a bottom surface) of an inner space of an arc tube into a flat surface (see Patent Literature 5).

### Patent Literature 1: Japanese Patent Application Laid-open No. 1999-238488

### Non-Patent Literature 1: Japan Electric Lamp Manufactures Association Standards JEL 215 “Automobile Headlight HID Light Source”

### Patent Literature 2: Japanese Patent Application Laid-open No. 2001-006610

### Patent Literature 3: Japanese Patent Application Laid-open No. 2001-313001

### Patent Literature 4: Japanese Patent Application Laid-open No. 2003-187742

### Patent Literature 5: Japanese Patent Application Laid-open No. 2003-229058

### DISCLOSURE OF THE INVENTION

### Problem to be Solved by the Invention

It is an object of the present invention to provide a mercury-free metal halide lamp which has rising of a light flux immediately after starting improved by using a configuration different from a prior art, and is more practical and suitable for a headlight, a metal halide lamp lighting device and a headlight using this.

### Means for Solving the Problem

A metal halide lamp according to the present invention comprises: a translucent air-tight container having an inner volume which is not greater than 0.1 cc, including an enclosure portion forming an inner space having a flat surface on a bottom surface, and having a ratio D/L satisfying the following expression: 0.25≦D/L≦0.43 where D is a distance between the bottom surface and a top surface of the inner space at a central portion in a tube-axis direction, and L is a length of the enclosure portion; a pair of electrodes sealed facing each other with an inter-electrode distance which is not greater than 5 mm in the translucent air-tight container; and a discharging medium containing a plurality of metal halogen compounds selected from a group of scandium (Sc), sodium (Na), indium (In), zinc (Zn) and a rare-earth metal and a rare gas but intrinsically not containing mercury (Hg), wherein a lamp power per unit inner surface area of the air-tight container is not smaller than 60 (W/cm²).

A metal halide lamp lighting device according to the present invention comprises: a metal halide lamp of the present invention; and a lighting circuit which turns on the metal halide lamp.

A headlight according to the present invention comprises: a headlight main body; a metal halide lamp of the present invention arranged in the headlight main body; and a lighting circuit which turns on the metal halide lamp.

### EFFECT OF THE INVENTION

According to the present invention, it is possible to provide a mercury-free metal halide lamp which is improved in rising of a light flux immediately after starting and suitable for a headlight with a structure different from a prior art, a metal halide lamp lighting device, and a headlight.

### BRIEF DESCRIPTION OF THE DRAWINGS

FIG. 1 is a front view showing an entire metal halide lamp for an automobile headlight as a first embodiment for carrying out a metal halide lamp according to the present invention.

FIG. 2 is an enlarged vertical cross-sectional view likewise showing an arc tube.

FIG. 3 is likewise a lateral cross-sectional view.

FIG. 4 is a graph showing a relationship between a ratio D/L, rising of a light flux and an amount of white turbidity in 1000 hours of lighting.

FIG. 5 is a front view showing a primary part of a metal halide lamp for an automobile headlight as a second embodiment for carrying out a metal halide lamp according to the present invention.

FIG. 6 is a graph likewise showing a relationship between a length and a change in chromaticity.

FIG. 7 is likewise a graph showing a relationship between a length and an incidence rate of leak.

FIG. 8 is a circuit diagram showing an embodiment for carrying out a metal halide lamp lighting device according to the present invention.

FIG. 9 is a conceptual view showing an automobile headlight as an embodiment for carrying out a headlight according to the present invention.

### EXPLANATIONS OF LETTERS AND NUMERALS

1 translucent air-tight container
1a enclosure portion
1a1 sealing portion
1a2 sealing
1a3 bottom surface
1a4 top surface
1a5 lower outer surface
1a6 upper outer surface
1b electrode
1c inner space
2 sealing metal foil
3A external lead line
3B external lead lines
IT arc tube

### BEST MODE FOR CARRYING OUT THE INVENTION

Embodiments for carrying out the present invention will now be described hereinafter with reference to the accompanying drawings.

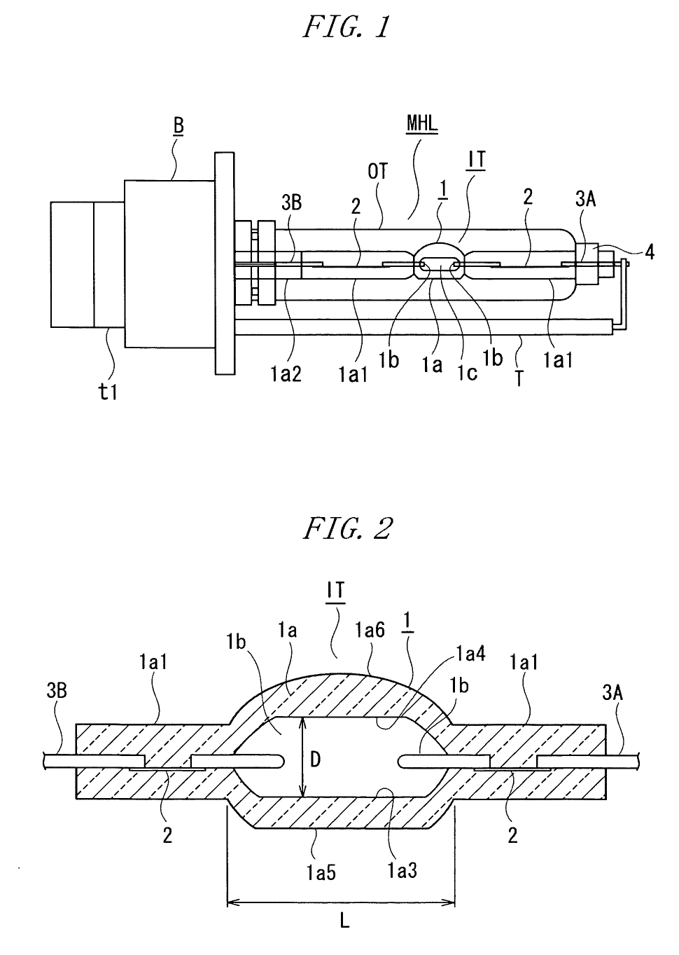

A metal halide lamp MHL for an automobile headlight in a first embodiment according to the present invention shown in FIGS. 1 to 3 is provided with an arc tube IT, an insulating tube T, an outer tube OT and a mouth ring B.

[Arc Tube IT] The arc tube IT is provided with a translucent air-tight container 1, a pair of electrodes 1b and 1b, a pair of external lead lines 3A and 3B, and a discharging medium.

(Translucent Air-tight Container 1) The translucent air-tight container 1 is fire-resistant and translucent, has an inner volume which is not greater than 0.1 cc, is provided with an enclosure portion 1a formed with an inner space 1c having a flat surface on a bottom surface 1a3, and has a relationship in which a radio D/L satisfies an expression 0.25≦D/L≦0.46, where D is a distance between the bottom surface 1a3 and a top surface 1a4 at a central part of the inner space 1c in a tube-axis direction, and L is a length of the enclosure portion.

It is to be noted that the distance D is a distance between the bottom surface 1a3 and the top surface 1a4 at the central part in the inner space 1c of the translucent air-tight container 1 along the tube-axis direction, but it is a distance measured at a position opposed to a point crossing a tube axis with respect to a direction perpendicular to the tube axis connecting the later-described pair of electrodes 1b and 1b with each other. The enclosure portion length L is a length of the enclosure portion 1a in the tube-axis direction, and it means a distance between a pair of discontinuous parts formed between both end sides of the enclosure portion 1a and a pair of sealing portions 1a1 when the translucent air-tight container 1a is provided with the sealing portions 1a1 and 1a1 at both ends of the enclosure portion 1a.

Further, in regard to a shape of the inner shape 1c in the translucent air-tight container 1, a remaining part excluding the flat surface part on the bottom surface 1a3 preferably has a lateral cross section having a substantially circular shape, and preferably has a cylindrical or gentle spindle-like shape in the tube-axis direction. Although an external shape opposite to the bottom surface 1a3 of the inner space 1c in the translucent air-tight container 1 is not restricted in particular, a flat surface is preferably formed. It is to be noted that the flat surface of the inner space 1c may have not only a completely flat shape but also slight irregularities or a gently curved shape as long as a flat shape is formed as a whole.

It is to be noted that, in the enclosure portion 1a of the translucent air-tight container 1, an upper outer surface 1a6 facing the top surface 1a4 of the inner space 1c has an elliptic spherical shape, and a wall thickness between these surfaces is large. On the contrary, a lower outer surface 1a5 facing the bottom surface 1a3 of the inner space 1c forms a flat surface parallel with the bottom surface 1a3, and a wall thickness between these surfaces is relatively small.

Furthermore, the phrase that the translucent air-tight container is “fire-resistant and translucent” means that a light leading portion which is a part from which light is to be led to at least the outside of the enclosure portion 1a has translucency and the translucent air-tight container has at least heat-resisting properties to sufficiently resist a regular operating temperature of the metal halide lamp MHL. Therefore, the translucent air-tight container 1 may be formed of any material as long as it is a material having fire-resisting properties and the necessary light leading portion can lead to the outside visible light in a desired wavelength band generated due to discharging. For example, the translucent air-tight container 1 can be formed of translucent ceramics or quartz glass. It is to be noted that quartz glass having a high linear transmission factor is generally used for the translucent air-tight container 1 in case of the metal halide lamp for a headlight. Moreover, in a case where this container is formed of quartz glass, a transparent film having halogen-resisting properties or halide-resisting properties can be formed on the inner surface of the enclosure portion 1a of the translucent air-tight container 1 or the inner surface of the translucent air-tight container 1 can be modified as required.

Although the inner space 1c of the translucent air-tight container 1 has an inner volume which is not greater than 0.1 cc as described above, the inner volume is preferably not greater than 0.05 cc in case of a headlight.

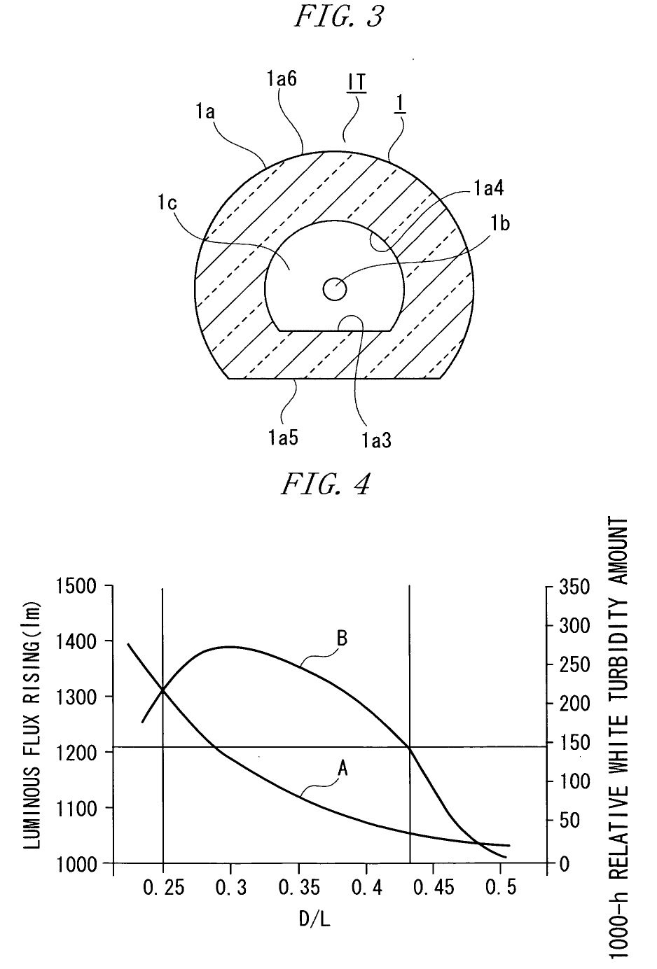

The inner space 1c has an elongated shape extending in the tube-axis direction, a lateral cross section preferably forming a basic shape which is a circular shape as shown in FIG. 3, and a columnar shape in the tube-axis direction. As a result, since the discharging arc is to be upwardly curved in horizontal lighting, it approaches the top surface 1a4 of the inner space 1c in the enclosure portion 1a, thereby hastening an increase in temperature on the top surface 1a4 of the enclosure portion 1a. Additionally, the bottom of the cylindrical part of the inner space 1c is cut, thus forming the bottom surface 1a3 consisting of a flat surface. Therefore, the top surface 1a4 of the inner space 1c is formed of an apex part of a cylindrical shape.

Incidentally, in order to form the bottom surface 1a3 consisting of a flat surface in the inner space 1c of the translucent air-tight container 1, it is good enough to form the translucent air-tight container 1 in which the inner space 1c has a substantially cylindrical shape before attaching electrodes, then thermally soften the translucent air-tight container 1, and press the bottom surface thereof against a flat reference surface or the like. When the bottom outer surface 1a5 facing the bottom surface 1a3 of the inner space 1c is formed into a relatively thin flat surface with respect to the similar part of the upper surface 1a4, a higher temperature of the bottom surface 1a3 of the translucent air-tight container 1 can be further easily maintained.

Moreover, a wall thickness of a central part of the enclosure portion 1a can be relatively increased in the translucent air-tight container 1. That is, a wall thickness of a substantially central part along an inter-electrode distance can be formed larger than a wall thickness of each of both sides. As a result, heat transmission of the translucent air-tight container 1 is improved, and an increase in temperature of a discharging medium which has adhered to the bottom surface 1a3 and a side inner surface of its inner space 1c is hastened, thus effectively expediting rising of a light flux.

When the translucent air-tight container 1 is formed of quartz glass, a pair of sealing portions 1a1 and 1a1 can be formed at both ends of the enclosure portion 1a in the tube-axis direction. The pair of sealing portions 1a1 and 1a1 are means for sealing the enclosure portion 1a, having shaft portions of later-described electrodes 1b embedded therein, and contributing to air-tight introduction of a current from a non-illustrated light circuit into the electrodes 1b, and they are integrally extended from both ends of the enclosure portion 1a. Furthermore, in order to seal and attach electrodes 1b and air-tightly introducing a current to the electrodes 1b from the lighting circuit, appropriate air-tight sealing/conducting means, preferably a sealing metal foil 2 is air-tightly embedded.

It is to be noted that the sealing metal foil 2 is means which is air-tightly embedded in each sealing portion 1a1 and functions as a current conductor in cooperation with the sealing portion 1a1 maintaining air tightness in the enclosure portion 1a of the translucent air-tight container 1, and it is preferable to use a foil of molybdenum (Mo), a rhenium-tungsten alloy (W—Re) or the like as a material when the translucent air-tight container 1 is formed of quartz glass. It is to be noted that molybdenum is oxidized when its temperature reaches approximately 350° C., and hence this metal foil is embedded so that a temperature at end portions on the outer side is lowered. Additionally, in case of the rhenium-tungsten alloy, since a content ratio of rhenium in the alloy is not greater than 37 mass %, an alloy having excellent processability can be obtained.

Although the method of embedding the sealing metal foil 2 in each sealing portion 1a1 is not restricted in particular, a reduced-pressure sealing method, a pinch sealing method or the like can be solely used or a combination of these method can be adopted. In case of a metal halide lamp used for a headlight which has a small shape with an inner volume of 0.1 cc or below and in which a rare gas such as xenon (Xe) is sealed at a room temperature with a barometric pressure of 5 or above, the latter case is preferable.

Further, in FIG. 1, after forming the left sealing portion 1a1, a sealing tube 1a2 is integrally extended from an outer end portion of the sealing portion 1a1 to be led into a later-described mouth ring B without being cut off.

(Pair of Electrodes 1b and 1b) The pair of electrodes 1b and 1b are enclosed and separated to face each other in both ends of the enclosure portion 1a of the translucent air-tight container 1. Since the inner volume of the inner space 1c of the metal halide lamp MHL is as small as 0.1 cc or below, an inter-electrode distance is not greater than 5 mm, and it is set to 4.2±0.1 mm which is a standardized value in case of a headlight. Furthermore, in each of the pair of electrodes 1b and 1b, it is desirable for a diameter of its shaft portion to be generally set to an appropriately value in a range of 0.25 to 0.5 mm, preferably a range of 0.25 to 0.35 mm.

Moreover, each of the pair of electrodes 1b and 1b has a refractory metal shaft portion formed of, e.g., tungsten (W), doped tungsten, rhenium (Re), a tungsten-rhenium alloy (W—Re) or the like, a proximal end of each shaft portion is, e.g., welded to each sealing metal foil 2 to be embedded in the sealing portion 1a1, an intermediate part of the shaft portion is gently supported by the sealing portion 1a1 of the translucent air-tight container 1, and distal ends of the sealing members are separated to face each other and arranged at both ends of the inner space 1c in such a manner that these ends face the inner space 1c of the translucent air-tight container 1.

Moreover, in a case where the metal halide lamp MHL is a headlight, when the shaft portion of each electrode 1b is extended to the distal end without increasing its diameter and a shape of the distal end is formed into a truncated conical shape, a semispherical shape or a semielliptic shape, a starting point of a discharging arc can be readily stabilized. Additionally, when a small projection is formed at the distal end, an effect can be synergistically increased. It is to be noted that the distal end of the electrode 1b is formed into a semispherical shape having a curvature which is ½ of a diameter of the electrode shaft as shown in FIG. 2 in this embodiment. However, if needed, a part of the electrode 1b in the vicinity of the distal end can be also formed into, e.g., a substantially spherical shape or an elliptic shape having a diameter larger than that of the shaft portion. That is, since the number of times of flashing of the lamp is extremely increased and a larger current than that in a steady mode is flowed at the time of start, when a diameter of the entire electrode 1b is increased in accordance with this configuration, a constituent of the translucent air-tight container 1 which is in contact with the electrode shaft receives heat stress every time flashing is performed, and a crack is apt to occur. Thus, forming a large-diameter portion in the electrode 1b in the vicinity of the distal end can allow the electrode 1b to cope with flashing, but a crack is hardly produced since a diameter of the shaft portion is not increased.

Further, the electrode 1b may be configured to operate with either an alternating current or a direct current. When an alternating current is used for operation, the pair of electrodes 1b have the same configuration. When a direct current is used for operation, since a temperature is generally precipitously increased in an anode, forming a large-diameter portion in the vicinity of a distal end can enlarge a discharging area and cope with frequent flashing. On the other hand, a large-diameter portion does not have to be formed in a cathode.

(Pair of External Lead Lines 3A and 3B) In each of the pair of external lead lines 3A and 3B, a distal end is welded on an opposite side of the other end of the sealing metal foil 2, i.e., a connecting part of the shaft portion of the electrode 1b in the sealing portion 1a1 at each of both ends of the translucent air-tight container 1, and a distal end side is led to the outside. In FIG. 1, the external lead line 3A led to the right-hand side from the arc tube IT is folded back at an intermediate portion along a later-described outer tube OT, led into a later-described mouth ring B and connected to one of mouth ring terminals t1. In FIG. 1, the external lead line B led to the left-hand side from the arc tube IT is extended along the tube axis in the sealing tube 1a2, led into the mount ring B and connected with the other one (not shown) of the mouth ring terminals.

(Discharging Medium) The discharging medium contains a metal halogen compounds and a rare gas, but intrinsically does not contain mercury. The metal halogen compounds include a plurality of types of metal halogen compounds selected from a group consisting of scandium (Sc), sodium (Na), indium (In), zinc (Zn) and a rare-earth metal. However, the discharging medium is not restricted to a configuration consisting of metal halogen compounds belonging to the above-described group alone, and it is allowed to supplementarily contain metal halogen compounds other than those in the group. For example, adding a halogen compound of thallium (Tl) as a main light-emitting material can further improve a luminous efficiency.

Further, metal halogen compounds for lamp voltage formation in the following group can be added as well as zinc (Zn). That is, a lamp voltage can be adjusted to a desired condition by adding one or more types of metal halogen compounds selected from a group consisting of magnesium (Mg), cobalt (C), chrome (Cr), manganese (Mn), antimony (Sb), rhenium (Re), gallium (Ga), tin (Sn), iron (Fe), aluminum (Al), titanium (Ti), zirconium (Zr) and hafnium (Hf). Each of all metals belonging to the above-described group is a metal which does not emit light in a visible band because of a high vapor pressure or a metal which relatively rarely produces luminescence, i.e., a metal which is not expected as a luminescent metal which earns a light flux but is suitable to mainly form a lamp voltage.

The rare gas functions as a starting gas and a buffer gas, and one or a plurality of types of rare gases, e.g., argon (Ar), krypton (Kr) and xenon (Xe) can be used. Further, as the metal halide lamp for an automobile headlight, when xenon is enclosed with a barometric pressure of 5 or above, or preferably in a barometric pressure range of 7 to 17, or more preferably in a barometric pressure range of 9 to 15, or when it is enclosed in such a manner that a pressure in the inner space has a barometric pressure value of 50 or above at the time of lighting, white light emission of Xe can be contributed as a light flux at the timing of rising if a vapor pressure of the luminescent metal is low immediately after starting.

Mercury will now be described. In the present invention, a phrase “does not intrinsically contain mercury” means that not only mercury (Hg) is not enclosed at all but existence of mercury of less than 2 mg, or preferably 1 mg or below per cc of the inner volume of the air-tight container is allowed. However, enclosing no mercury at all is environmentally desirable. In a case where a lamp voltage of the discharging lamp is increased to a necessary value by mercury vapor like a prior art, it can be said that an amount of mercury is substantially small since 20 to 40 mg is enclosed per cm³ of the inner volume of the air-tight container or 50 mg or more is enclosed in some cases in a short arc shape in the prior art.

As halogen constituting halogen compounds, iodine is optimum in halogen in regard to responsiveness, and at least the above-described major luminescent metals are mainly enclosed as iodides. However, if needed, it is possible to concomitantly use different halogen compounds like iodides or bromides.

[Insulating Tube T] The insulating tube T is formed of ceramics, and the insulating tube T covers the external lead line 3A.

[Outer Tube OT] The outer tube OT is formed of quartz glass, high-silicate glass or the like, and it is means for accommodating at least primary parts of the arc tube IT. Moreover, it blocks off ultraviolet rays radiated from the arc tube IT to the outside, mechanically protects, prevents fingerprints or fat of humans from being a factor of devitrification when the translucent air-tight container 1 is touched by a hand, or keeps the heat in the translucent air-tight container 1. Additionally, the outer tube OT may be air-tightly sealed with respect to outside air in accordance with each purpose, or air or an inert gas whose pressure has been reduced to be substantially equal to that of outside air may be enclosed in this tube. Further, if needed, the outer tube may communicate with outside air. Furthermore, a light shielding film may be arranged on an outer surface or an inner surface of the outer tube OT.

Moreover, in the illustrated embodiment, when forming the outer tube OT, the outer tube OT can be configured to be supported by the translucent air-tight container 1 by glass-depositing both ends thereof to the sealing portions 1a1 extending from both ends of the translucent air-tight container 1 in the tube-axis direction. The outer tube OT has the ultraviolet protection performance and accommodates the arc tube IT therein, and each of diameter reduced portions 4 at both ends thereof is glass-deposited to the sealing portion 1a1 of the discharging container IT. However, the inside is not airproofed but communicates with outside air.

[Mouth Ring B] The mouth ring B is means functioning to connect the metal halide lamp HML with a non-illustrated lighting circuit and mechanically support the same, it is standardized as an automobile headlight in the illustrated conformation and configured to erectly support the arc tube IT and the outer tube OT along the central axis and to be detachably disposed on a rear surface of the automobile headlight.

[Function of Metal Halide Lamp according to Present Invention] In case of lighting a conventional metal halide lamp in a horizontal state or an inclined state close to a horizontal state, since plasma of the arc is generally upwardly curved from the immediate aftermath of starting to stable lighting, the plasma is deviated toward the upper surface side of the inner space of the translucent air-tight container from the tube axis connecting the pair of electrodes. Therefore, although a temperature of the upper surface of the inner space is apt to be increased due to approximation of the plasma, a temperature of the bottom surface is hardly increased since a distance from the plasma of the arc is increased.

In the present invention, since the bottom surface 1a3 of the inner space 1c in the translucent air-tight container 1 forms a flat surface to facilitate raising the level, a distance between the plasma of the arc and the bottom surface 1a3 is relatively appropriately reduced in a period from the immediate aftermath of starting to stable lighting as long as the ratio D/L satisfies the above-described expression, thereby facilitating an increase in temperature immediately after starting. Therefore, the metal halogen compounds of the discharging medium are heated, vaporization of these compounds is facilitated, and an increase in vapor pressure of the metal halogen compounds is thereby hastened, thus improving rising of a light flux immediately after starting.

However, a tendency that the inner surface of the translucent air-tight container 1 becomes opaque is exponentially increased as the ratio D/L is reduced, and hence the ratio D/L must be not smaller than 0.25. It is to be noted that it is preferably not smaller than 0.29. Furthermore, rising of a light flux immediately after starting is lowered as the ratio D/L is increased, and it is precipitously lowered to reduce the effect of improving rising of a light flux when the ratio D/L exceeds 0.43, whereby the ratio D/L must be not greater than 0.43. It is to be noted that a desirable range of the ratio D/L is 0.29≦D/L≦0.4, or preferably 0.32≦D/L≦0.4. In case of the metal halide lamp for a headlight, an appropriate value of the distance D can be selected from a range of 1.5 to 3 mm and an appropriate value of the enclosure portion length L can be selected from a range of 6 to 8.5 mm based on the above-described ranges.

Therefore, according to the present invention, since the ratio D/L satisfies the above-described expression, rising of a light flux immediately after starting can be improved. Therefore, it is possible to obtain the excellent metal halide lamp suitable as a headlight which can facilitate generation of at least 80% of a rated light flux after four seconds from starting and does not cause a problem of white turbidity of the translucent air-tight container.

Moreover, besides the requirement of the ratio D/L, the present invention specifies as respective requirements that (1) an inter-electrode distance is not greater than 5 mm, (2) metal halogen compounds of the discharging medium are a plurality of metal halogen compounds selected from a group consisting of scandium (Sc), sodium (Na), indium (In), zinc (Zn) and a rare-earth metal, (3) the discharging medium does not intrinsically contain mercury and (4) a lamp power per unit inner surface area of the air-tight container, i.e., a tube wall load is not smaller than 60 (W/cm²), and its reasons are as follows. That is,

(1) the metal halide lamp having an inter-electrode distance which is not greater than 5 mm is used for an application such as a headlight or a projection where excellent rising of a light flux immediately after starting is required or preferable, and hence the present invention is effective. It is to be noted that, as the metal halide lamp for an automobile headlight, an inter-electrode distance 4.2 mm is standardized, and 2 mm or below is preferable for a projection.

(2) Since the metal halide compounds of the discharging medium are a plurality of types of metal halogen compounds selected from the above-described group, the metal halide lamp compatible with various applications can be obtained. In the group, scandium (Sc) and sodium (Na) highly efficiently emit white-color-based light in accordance with a combination of these materials in particular, they can be adopted as major visible-light-emitting materials. Indium (In) and zinc (Zn) emit blue-color-based light, whereby they can be adopted for adjusting chromaticity. Additionally, since a vapor pressure of zinc is relatively high, it can be adopted for formation of a lamp voltage. The rare-earth metal can be mainly adopted for emission of visible light and adjustment of chromaticity. It is to be noted that the rare-earth metal has some functions for formation of a lamp voltage.

Therefore, appropriately selecting a plurality of metal halogen compounds belonging to the above-described group can obtain various kinds of small metal halide lamps having a high optical output for a headlight, a projection and others.

(3) In regard to the fact that the discharging medium intrinsically does not contain mercury, containing no mercury (Hg) at all is preferable for a reduction of environmental load substances, but containing mercury to the extent that functions and effects of the present invention are not essentially affected, in other words, containing mercury in an amount equal to that of impurities is allowed.

(4) The tube wall load is not smaller than 60 (W/cm²) in order to clarify that the present invention is effective with respect to various kinds of small metal halide lamps having a high optical output for a headlight, a projection and others.

Embodiment 1 as well as Comparative Example 1 and Comparative Example 2 will now be described. It is to be noted that Comparative Example 1 corresponds to a commercially available automobile headlight metal halide lamp containing mercury, and Comparative Example 2 corresponds to an automobile headlight mercury-free lamp which does not comprise the configuration of the present invention.

### EMBODIMENT 1

Translucent air-tight container 1: an inner volume 0.020 cc of an inner space, a distance D 2.3 mm, an internal diameter 2.6 mm, an enclosure portion length 7.0 mm, an enclosure portion external diameter 6.0 mm, D/L 0.33
Inter-electrode distance: 4.2 mm
Discharging medium: a metal halogen compound Scl₃-Nal-Znl₂-Inl-Csl, a total 0.5 mg, a rare gas Xe 10 atm
Input power immediately after starting: 85 W
Input current immediately after starting: 2.8 A
Lamp voltage in a stable state: 42 V
Lamp current in a stable state: 0.8 A
Lamp power in a stable state: 35 W
Light flux after four seconds from starting: 1370 μm

### COMPARATIVE EXAMPLE 1

Translucent air-tight container 1: an inner volume 0.020 cc of an inner space, an internal diameter 2.6 mm, an enclosure portion length 7.0 mm, an enclosure portion external diameter 6.0 mm
Inter-electrode distance: 4.2 mm
Discharging medium: a metal halogen compound Scl₃-Nal-Hg, a rare gas Xe approximately 4 atm
Input power immediately after starting: 65 W
Input current immediately after starting: 3.0 A
Lamp voltage in a stable state: 90 V
Lamp current in a stable state: 0.4 A
Lamp power in a stable state: 35 W
Light flux after four seconds from starting: 2900 μm

### COMPARATIVE EXAMPLE 2

Translucent air-tight container 1: an inner volume 0.033 cc of an inner space, an internal diameter 2.6 mm, an enclosure portion length 7.8 mm, an enclosure portion external diameter 6.0 mm
Inter-electrode distance: 4.2 mm
Discharging medium: a metal halogen compound Scl₃-Nal-Znl₂-Inl-Csl, a total 0.8 mg, a rare gas Xe 12 atm
Input power immediately after starting: 85 W
Input current immediately after starting: 2.8 A
Lamp voltage in a stable state: 45 V
Lamp current in a stable state: 0.8 A
Lamp power in a stable state: 35 W
Light flux after four seconds from starting: 1200 μm

A description will now be given as to a relationship between a ratio D/L, a light flux after four seconds from starting, i.e., rising of a light flux at the time of starting and an amount of white turbidity in 1000 hours of lighting when the metal halide lamp was manufactured while changing the ratio D/L of the translucent air-tight container in many ways and this lamp was subjected to a lighting test in the embodiment with reference to FIG. 4. It is to be noted that, in the drawing, a horizontal axis represents the ratio D/L, a right-hand side of a vertical axis represents a 1000 h relative white turbidity amount, and a left-hand side of the same represents rising of a light flux (lm), respectively. In the drawing, a curve A indicates a white turbidity amount and a curve B indicates rising of a light flux.

As indicated by the curve A in the drawing, although a white turbidity amount is apt to exponentially occur when the ratio D/L is less than 0.25, the white turbidity amount is reduced to fall within an allowable range when the ratio D/L is not smaller than 0.25, or preferably not smaller than 0.29. On the other hand, in regard to rising of a light flux after four seconds from starting, as indicated by the curve B in the drawing, the white turbidity amount is precipitously reduced when the ratio D/L exceeds 0.43, so that 1200 μm or above cannot be satisfied.

Therefore, in the small high-optical-output type mercury-free metal halide lamp, it can be understood from FIG. 4 that satisfying the expression 0.25≦D/L≦0.43 is effective for improving rising of a light flux immediately after starting and suppressing white turbidity.

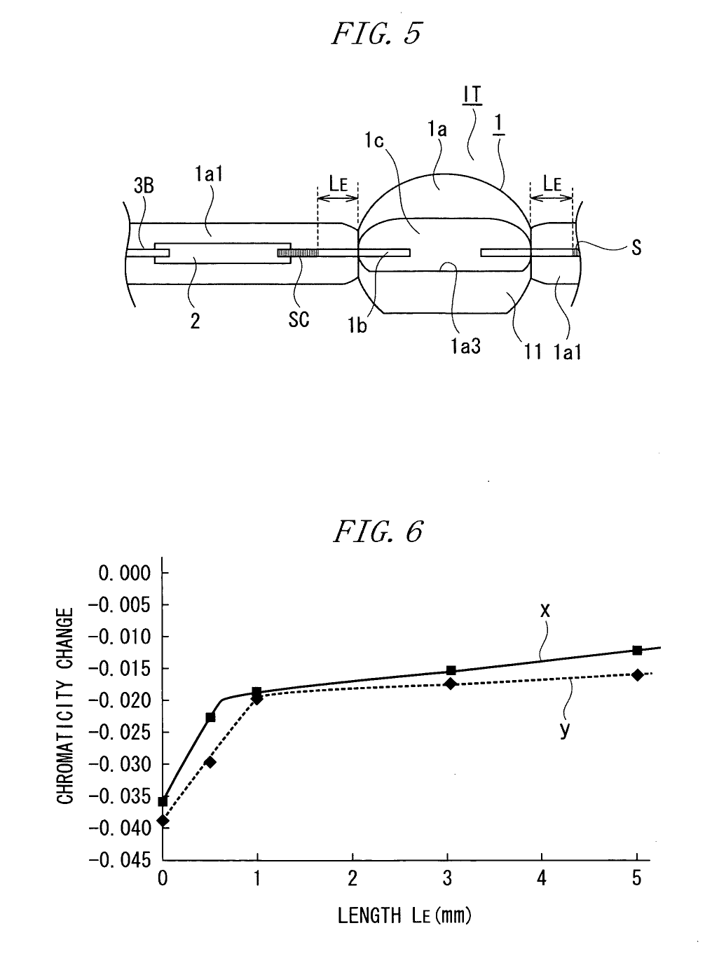

A second conformation for carrying out a metal halide lamp according to the present invention will now be described with reference to FIGS. 5 to 7. As shown in FIG. 5, the second conformation is characterized in that each of a pair of electrodes 1b and 1b has a metal coating body SC arranged on a proximal end side of a shaft portion thereof. It is to be noted that all or a part of the configuration described in the first embodiment of the present invention shown in FIGS. 1 to 3 can be adopted as a configuration of this conformation except the metal coating body SC. However, flat opposed surfaces of a translucent air-tight container 1 and structures concerning these surfaces may not be provided if desired.

The metal coating body SC is a member consisting of a fire-resisting metal and covering the proximal end side of the shaft portion of each electrode 1b. As the fire-resisting metal, it is possible to selectively use tungsten, a rhenium-tungsten alloy, molybdenum and others.

Further, a length L_{E} (mm) of a part of the shaft portion of the electrode 1b embedded in the sealing portion 1a1 which does not have the metal coating body SC arranged thereof satisfies an expression 1≦L_{E}≦5.

Furthermore, the metal coating body SC is allowed to be a coil body, a sleeve body, a coating film body or the like.

Embodiment 2 in the second conformation according to the present invention will now be described.

### EMBODIMENT 2

Metal coating body SC: it is constituted of a coil body by way of example.

A diameter of the coil is 0.07 mm, a coil pitch is 100%, a length in an electrode-axis direction is 5.5 mm, and a length of the coil on a sealing metal foil 2 in the electrode-axis direction is 1.5 mm.

A diameter of a shaft portion of the electrode 1b is 0.3 mm in a sealing portion, and it is 0.038 mm in a discharging space.

Translucent air-tight container 1: an internal diameter of its enclosure portion 1a is 2.6 mm, an external diameter of the same is 6.0 mm and a maximum length of the same in a longitudinal direction is 6 mm.

Discharging medium: a metal halogen compound; 0.5 mg of scandium iodium-sodium iodium-zinc iodium, a rare gas; xenon with a barometric pressure of approximately 11, mercury is not contained at all.

FIG. 6 is a graph showing a relationship between a length L_{E} (mm) and a change in chromaticity in the second embodiment according to the present invention. This graph is obtained by plotting changes in chromaticity when a plurality of metal halide lamps were manufactured with the length L_{E} (mm) of the shaft portion of the electrode 1b embedded in the sealing portion 1a1 of the translucent air-tight container 1 which is not covered with the metal coating body SC being adjusted to a predetermined distance while changing a length of the metal coating body SC and each of these metal halide lamp was subjected to a 2000-hour flashing test in an EU 120-minute mode as a life duration test condition of a metal halide lamp for an automobile headlight specified in Japan Electric Lamp Manufactures Association Standards JEL 215 “Automobile Headlight HID Light Source”.

It is to be noted that a vertical axis represents a length L_{E} (mm) and a horizontal axis represents a change in chromaticity in FIG. 6, respectively. Moreover, in the drawing, a curve x indicates chromaticity from blue to red and a curve y indicates chromaticity from blue to green.

As can be understood from FIG. 6, in regard to the chromaticity x, there is a change point in a ratio of a chromaticity change when the length L_{E} (mm) is approximately 0.7 mm, and the chromaticity change is rarely generated even though the length L_{E} (mm) is increased beyond this value. However, when the length L_{E} (mm) is reduced to be shorter than 0.7 mm, the chromaticity change precipitously increases.

In regard to the chromaticity y, there is a change point in a ratio of a chromaticity change when the length L_{E} (mm) is approximately 1 mm, and substantially the same results as those of the chromaticity x are obtained when the length L_{E} (mm) is changed to be longer than or shorter than 1 mm.

As apparent from the above description, when the length L_{E} (mm) is not smaller than 1 mm, chromaticity changes in the chromaticity x and the chromaticity y can be reduced.

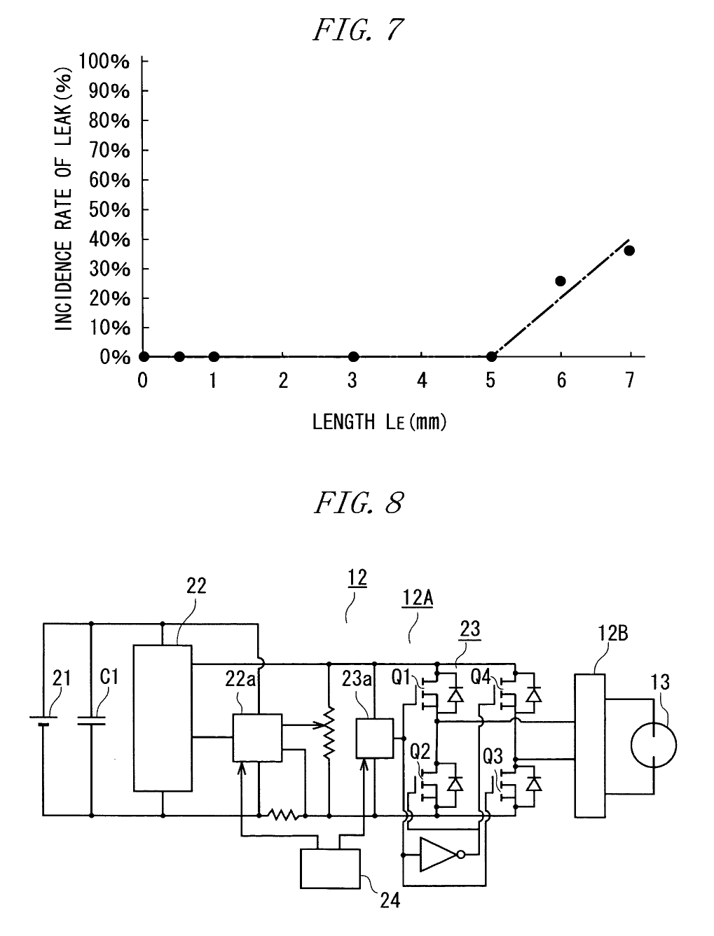

FIG. 7 is a graph showing a relationship between the length L_{E} (mm) and an incidence rate of leak in the second conformation according to the present invention. This graph is obtained by plotting an incidence rate of leak after a 2000-hour flashing test in an EU 120-minute mode with respect to the above-described manufacture examples. It is to be noted that a vertical axis represents the length L_{E} (mm) and a horizontal axis represents an incidence rate of leak (%) in FIG. 7, respectively.

As can be understood from FIG. 7, although a crack which may result in leak is not produced when the length L_{E} (mm) is 0 to 5 mm, an incidence rate of crack which may result in leak is increased when this length exceeds 5 mm.

That is, when the length L is not smaller than 0 mm and not greater than 5 mm, occurrence of a crack which may result in leak can be reduced.

Therefore, in the second conformation, satisfying the expression 1≦L_{E}≦5 can obtain an effect of avoiding occurrence of leak while suppressing a change in chromaticity in a life duration.

It is to be noted that the present invention is not restricted to the above-described configurations, and it can be changed as follows.

### 1. An Arrangement Position of the Metal Coating Body SC

The metal coating body SC may be arranged between a position avoiding the part connecting the sealing metal foil 2 with the end of the shaft portion of the electrode 1b and a position at which the length L_{E} is assured.

2. A Pitch when the Metal Coating Body SC is a Coil Body

When the metal coating body SC is a coil body, it is preferable for a pitch to be close to 100% in order to obtain a high effect against occurrence of a crack which may result in leak, but it may be less than 100% if desired.

3. The metal coating body SC may not be formed on an entire circumference of the shaft portion of the electrode 1b.

FIG. 8 is a circuit diagram showing one conformation for embodying a metal halide lamp lighting device according to the present invention. That is, the metal halide lamp lighting device is provided with a main lighting circuit 12A and a starter 12B. The main lighting circuit 12A is configured as follows, and can be attached to a later-described headlight main body 11.

A metal halide lamp 14 is formed of the metal halide lamp according to the present invention shown in FIGS. 1 to 3 or 5.

The main lighting circuit 12A is constituted of a direct-current power supply 21, a boosting chopper 22, an inverter 23 and a control circuit 24, and turns on the metal halide lamp 13.

The direct-current power supply 21 is formed of a battery power supply, a rectifying direct-current power supply or the like, and has a smoothing capacitor C1 connected between direct-current outputs.

The boosting chopper 22 boosts a direct-current voltage fed from the direct-current power supply 21 to a necessary voltage, smoothens it and supplies an input voltage to the later-described inverter 23. It is to be noted that reference character 22a denotes a driving circuit which drives a switching element of the boosting chopper 22.

The inverter 23 is formed of a full-bridge type inverter. Further, it bridge-connects four switching elements Q1 to Q4, and alternately switches the pair of switching elements Q1 and Q3 constituting opposed two sides and the pair of switching elements Q2 and Q4 constituting the other opposed two sides, thereby outputting an alternating voltage having a rectangular wave to a space between output ends of these switching elements. It is to be noted that reference character 23a designates a driving circuit which drives the respective switching elements Q1 to Q4 of the inverter 23.

The control circuit 24 controls the boosting chopper 22 and the inverter 23 to necessary states. For example, when the metal halide lamp 13 is in a cooled state, the control circuit 24 controls in such a manner that the metal halide lamp 13 is turned on with a power which is approximately twofold or more, e.g., approximately 2.3-fold of a rated lamp power for several seconds immediately after starting and the power is then gradually reduced to a rated lamp power in a stable lighting mode.

The starter 12B outputs a high-voltage pulse when starting the metal halide lamp 13, and applies this pulse to the metal halide lamp 13 in order to instantaneously start the lamp.

Then, the metal halide lamp lighting device starts and stably turns on the metal halide lamp 13. Furthermore, as the metal halide lamp lighting device for an automobile headlight, this device starts the metal halide lamp 13, inputs a power which is twofold or more of a rated lamp power for several seconds immediately after start of lighting, then reduces the lamp power at a fixed rate when halogen compounds are precipitously vaporized, and subsequently controls and turns on the metal halide lamp while gradually decreasing the reduction rate from a large value to the rated lamp power so that the control shifts to stable lighting.

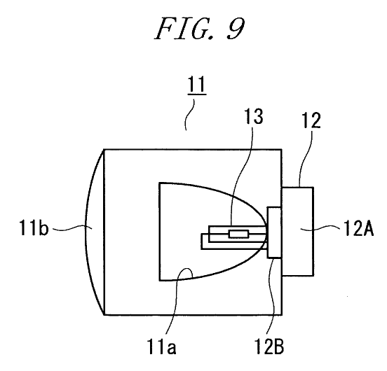

FIG. 9 shows an automobile headlight as one conformation for carrying out a headlight according to the present invention. In the drawing, reference numeral 11 denotes a headlight main body; 12, a lighting circuit; and 13, a metal halide lamp.

In the present invention, the headlight main body 11 means a remaining part of a headlight excluding the metal halide lamp 13 and the lighting circuit 12. Additionally, the headlight main body 11 has a container shape, and includes a reflection mirror 11a, a lens 11b on a front surface thereof, a non-illustrated lamp socket and others.

1. A metal halide lamp comprising:
a translucent air-tight container having an inner volume which is not greater than 0.1 cc, including an enclosure portion forming an inner space having a flat surface on a bottom surface, and having a ratio D/L satisfying the following expression:
0.25≦D/L≦0.43
where D is a distance between the bottom surface and a top surface of the inner space at a central portion in a tube-axis direction, and L is a length of the enclosure portion;
a pair of electrodes sealed facing each other with an inter-electrode distance which is not greater than 5 mm in the translucent air-tight container; and
a discharging medium containing a plurality of metal halogen compounds selected from a group of scandium (Sc), sodium (Na), indium (In), zinc (Zn) and a rare-earth metal and a rare gas but intrinsically not containing mercury (Hg),
wherein a lamp power per unit inner surface area of the air-tight container is not smaller than 60 (W/cm²).

2. The metal halide lamp according to claim 1, wherein the translucent air-tight container comprises a sealing portion which is continuous with each of both ends of the enclosure portion and has a sealing metal foil air-tightly embedded therein; and
each of the pair of electrodes has a metal coating body arranged on a proximal end side, a proximal end connected with the sealing metal foil, an intermediate portion piercing the sealing portion and a distal end exposed in the enclosure portion, a length L_{E} (mm) of a piercing portion at a part where the metal coating body is not arranged satisfying the following expression:
1≦L_{E}≦5

3. A metal halide lamp lighting device comprising:
a metal halide lamp according to claim 1 or 2; and
a lighting circuit which turns on the metal halide lamp.

4. A headlight comprising:
a headlight main body;
a metal halide lamp according to claim 1 or 2 arranged in the headlight main body; and
a lighting circuit which turns on the metal halide lamp.
